(19) United States
(12) Patent Application Publication
(10) Pub. No.: US 2025/0081213 A1
(43) Pub. Date: Mar. 6, 2025

(54) METHODS, APPARATUSES, AND STORAGE MEDIUM FOR CONFIGURING FRAME STRUCTURE FOR SIDELINK COMMUNICATION BETWEEN DEVICES

(71) Applicant: ZTE CORPORATION, Shenzhen (CN)

(72) Inventors: Youxiong LU, Shenzhen (CN); Weimin XING, Shenzhen (CN); Haigang HE, Shenzhen (CN)

(21) Appl. No.: 18/724,904

(22) PCT Filed: Jan. 5, 2022
(86) PCT No.: PCT/CN2022/070223

§ 371 Date: Jun. 27, 2024

(51) Int. Cl. H04W 72/25; H04W 72/0453

(52) U.S. Cl. CPC H04W 72/25; H04W 72/0453

(57) ABSTRACT

The present disclosure describes methods, apparatuses, and a storage medium for configuring a frame structure for sidelink communication between devices. The method includes configuring, by a first device, a frame for a sidelink communication in an unlicensed carrier, wherein: the frame comprises a physical sidelink channel assess channel (PSCACH) and a physical sidelink shared channel (PSSCH), the PSCACH locates at a starting position of the frame, and the PSCACH is configured to indicate share information of at least one access channel for the PSSCH; and sending, by the first device, the frame to a second device, wherein the second device is configured to determine, based on the share information indicated by the PSCACH, whether to share the at least one access channel for the sidelink communication.

### CROSS-REFERENCE TO RELATED APPLICATION(S)

This is a national stage application filed under 35 U.S.C. 371 based on International Patent Application No. PCT/CN2022/070223, filed Jan. 5, 2022, the disclosure of which is incorporated herein by reference in its entirety.

### TECHNICAL FIELD

The present disclosure is directed generally to wireless communications. Particularly, the present disclosure relates to methods, apparatuses, and a storage medium for configuring a frame structure for sidelink communication between devices.

### BACKGROUND

User equipments (UEs) in a wireless network may communicate data with one another via direct sidelink (SL) communication channels without the data being relayed by any wireless access network nodes. In some application scenarios of sidelink communications such as those involving vehicular wireless network devices, communication resource allocation and configuration for one communication terminal may involve another communication terminal in addition to a base station. It is critical to provide a resource allocation, provisioning, and release mechanism to enable low-power and efficient use of sidelink communication resources.

There are various problems/issues with the sidelink communication. One of the problems/issues may include that, a frame structure, which may be configured to intelligent transport system (ITS) and/or in licensed frequency carriers, may be configured without considering particular circumstances when frequency carriers includes non-licensed frequency carriers. Another one of the problems/issues may include that some transmission protocols/schemes may be configured to be shared among one or more device without considering particular circumstances when frequency carriers includes non-licensed frequency carriers.

The present disclosure describes various embodiments for configuring a frame structure for sidelink communication between devices in one or more unlicensed carrier, addressing one or more problems/issues and improving the efficiency of the sidelink communication between devices.

### SUMMARY

This document relates to methods, apparatuses, and a storage medium for wireless communication, and more specifically, for configuring a frame structure for sidelink communication between devices.

In one embodiment, the present disclosure describes a method for wireless communication. The method includes configuring, by a first device, a frame for a sidelink communication in an unlicensed carrier, wherein: the frame comprises a physical sidelink channel assess channel (PSCACH) and a physical sidelink shared channel (PSSCH), the PSCACH locates at a starting position of the frame, and the PSCACH is configured to indicate share information of at least one access channel for the PSSCH; and sending, by the first device, the frame to a second device, wherein the second device is configured to determine, based on the share information indicated by the PSCACH, whether to share the at least one access channel for the sidelink communication.

In another embodiment, the present disclosure describes a method for wireless communication. The method includes receiving from a first device, by a second device, a frame for a sidelink communication in an unlicensed carrier, wherein: the frame comprises a physical sidelink channel assess channel (PSCACH) and a physical sidelink shared channel (PSSCH), the PSCACH locates at a starting position of the frame, and the PSCACH is configured to indicate share information of at least one access channel for the PSSCH; obtaining, by the second device, the shared information from the PSCACH; and determining, by the second device based on the obtained share information, whether to share the at least one access channel for the sidelink communication.

In some other embodiments, an apparatus for wireless communication may include a memory storing instructions and a processor in communication with the memory. When the processor executes the instructions, the processor is configured to carry out the above methods.

In some other embodiments, an apparatus for wireless communication may include a memory storing instructions and a processor in communication with the memory. When the processor executes the instructions, the processor is configured to carry out the above methods.

In some other embodiments, a non-transitory computer-readable storage medium comprising instructions which, when executed by a computer, cause the computer to carry out the above methods.

The above and other aspects and their implementations are described in greater detail in the drawings, the descriptions, and the claims.

### BRIEF DESCRIPTION OF DRAWINGS

FIG. 1 illustrates an example diagram of a wireless communication network in accordance with various embodiments.

FIG. 2 shows an example of a wireless network node.

FIG. 3 shows an example of a user equipment.

FIG. 4 shows a flow diagram of a method for wireless communication.

FIG. 5A shows an exemplary schematic diagram of a method for wireless communication.

FIG. 5B shows another exemplary schematic diagram of a method for wireless communication.

FIG. 5C shows another exemplary schematic diagram of a method for wireless communication.

FIG. 6A shows an exemplary schematic diagram of a method for wireless communication.

FIG. 6B shows another exemplary schematic diagram of a method for wireless communication.

FIG. 6C shows another exemplary schematic diagram of a method for wireless communication.

FIG. 7 shows a flow diagram of a method for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various methods and devices for configuring a frame structure for sidelink communication between devices. In various embodiments, a “frame” may refer to a slot, or a frame with a certain frame structure including a set of slots or a portion of symbols in a set of slots. In various embodiments, a “frame” may not necessary have same meaning as a wireless frame in some telecommunication implementations.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

A vehicle network refers to a network system for wireless communication and information exchange among vehicles, pedestrians, roadside equipments, and the Internet and other data networks in accordance with various communication protocols and data exchange standards. Vehicle network communication helps improve road safety, enhance traffic efficiency, and provide broadband mobile data access and inter-network node data exchanges. The vehicle network communication may be categorized into various types as differentiated according to the communication endpoints, including but not limited to vehicle-to-vehicle (V2V) communication, vehicle-to-infrastructure/vehicle-to-network (V2I/V2N) communication, and vehicle-to-pedestrian (V2P) communication. These types of communication are referred to, collectively, as vehicle-to-everything (V2X) communication.

Such a vehicle network may heavily rely on sidelink communication between the terminal devices or user equipments (UEs) in the network. Sidelink communication, as used in this disclosure, refers to a direct wireless information exchange between UEs. Sidelink (SL) is a unilateral wireless communication service, i.e., the communication between the communication terminals or user equipment (UE). Vehicle networking refers to a large scale system for wireless communication and information exchange among vehicles, pedestrians, roadside equipment, and internet in accordance with agreed communication protocols and data exchange standards. The vehicle networking communications enable the vehicles to gain driving safety, improve traffic efficiency, and acquire convenience or entertainment information. The vehicle networking communication may be categorized into three types as per the objects of wireless communication: the communication between vehicles, i.e., vehicle-to-vehicle (V2V); the communication between vehicles and roadside equipment/network infrastructures, i.e., vehicle-to-infrastructure/vehicle-to-network (V2I/V2N); and the communication between vehicles and pedestrians, i.e., vehicle-to-pedestrian (V2P). These types of communications collectively are referred to as vehicle-to-everything (V2X) communication.

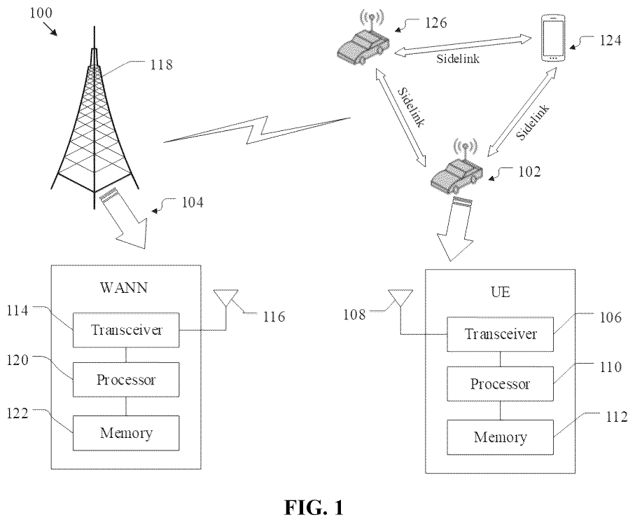

An example sidelink communication technology is illustrated as part of FIG. 1. While being capable of communicating among themselves using sidelinks, the various UEs described above may also be connected to wireless access networks, and to a core network via the access networks. The wireless access network and core network may be involved in configuring and provisioning communication resources needed for data and control information transmission/reception for sidelink communication. An example wireless access network may be based on, for example, cellular 4G LTE, 5G NR, or a future telecommunication generation (e.g, 6G) technologies and/or formats. FIG. 1 shows an example system diagram of a wireless access communication network 100 including UEs 102, 124, and 126 as well as a wireless access network node (WANN) 104. Each of the UEs 102, 124, and 126 may include but is not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. The UEs may indirectly communicate with each other via the WANN 104 or directly via sidelinks. As shown in FIG. 1, each of the UEs such as UE 102 may include transceiver circuitry 106 coupled to an antenna 108 to effectuate wireless communication with the WANN 104 or with another UE such as UE 124 or 126. The transceiver circuitry 106 may also be coupled to a processor 110, which may also be coupled to a memory 112 or other storage devices. The memory 112 may store therein computer instructions or code which, when read and executed by the processor 110, cause the processor 110 to implement various ones of the methods for sidelink resource allocation/configuration/release and data transmission/reception described herein.

Similarly, the WANN 104 may include a base station or other wireless network access points capable of communicating wirelessly over a network with one or more UEs and communicating with a core network. For example, the WANN 104 may be implemented in the form of a 4G LTE base station, a 5G NR base station, a 5G central-unit base station, or a 5G distributed-unit base station. Each type of these WANNs may be configured to perform a corresponding set of wireless network functions. The WANN 104 may include transceiver circuitry 114 coupled to an antenna 116, which may include an antenna tower 118 in various forms, to effectuate wireless communications with the UEs 102, 124, and 126. The transceiver circuitry 114 may be coupled to one or more processors 120, which may further be coupled to a memory 122 or other storage devices. The memory 122 may store therein instructions or code that, when read and executed by the processor 120, cause the processor 120 to implement various functions. These functions, for example, may include those related to the sidelink resource allocation, configuration, provisioning and releases described below.

For simplicity and clarity, only one WANN and three UEs are shown in the wireless communication access network 100. It will be appreciated that one or more WANNs may exist in the wireless communication network, and each WANN may serve one or more UEs. While the UEs 102, 124, and 126 of FIG. 1 are shown as being served within one serving cell, they may alternatively be served by different cells and/or by no cell. While various embodiments of sidelink communication below are discussed in the context of the particular example cellular wireless communication access network 100, the underlying principle apply to other types of wireless communication networks.

In V2X communication, a sidelink communication, and/or UE-UE direct communication (or device-to-device (D2D)), there may be two modes of resource allocation: model 1: a base station schedules to allocate resources; and mode 2: one or more UE independently selects resources. For mode 1, after scheduling by a central node, such as a base station, resources between UEs may be conflict-free (e.g., allocation and/or utilization). For mode 2, since there is no scheduling by a central node, UEs need to share resources according to certain rules while avoiding resource conflicts as much as possible. In LTE V2X and NR V2X, for the transmission characteristics of licensed carriers and/or intelligent transport system (ITS) for periodic services, one or more UE in mode 2 may learn the resource usage information in the future by receiving and sending sidelink control information (SCI) information sent by the UE. When performing resource selection, the one or more UE may let go of the resources that have been reserved by other UEs, so as to realize resource reuse among multiple UEs. For the UE in mode 1, it is expected that the resources indicated by the base station may not conflict with the resources of other UEs, and may not share the same resources with other UEs.

In various implementations, a physical layer may define PSCCH (Physical sidelink control channel), PSSCH (Physical sidelink shared channel), and/or PSFCH (Physical sidelink feedback channel). Among them, PSFCH and PSCCH/PSSCH may use resources in a time division multiplexing (TDM) manner in the time domain. PSCCH and PSSCH may share one or more sub-channel resources in a slot. For one transmission, one or more UE may need to map the data of different physical channels to at least one resource element (RE) corresponding to the channel respectively.

There are various problems/issues with the sidelink communication. One of the problems/issues may include that, a frame structure, which may be configured to intelligent transport system (ITS) and/or in licensed frequency carriers, may be configured without considering particular circumstances when frequency carriers includes non-licensed frequency carriers. Another one of the problems/issues may include that some transmission protocols/schemes may be configured to be shared among one or more device without considering particular circumstances when frequency carriers includes non-licensed frequency carriers. Another problem/issue may include that, for a transmission opportunity obtained by competition, such as an unlicensed carrier, how to achieve resource reuse between multiple UEs in a channel occupancy time (COT) period obtained through listen-before-talk (LBT), the frame structure defined by NR V2X, some communication method may be no longer applicable.

The present disclosure describes various embodiments for configuring a frame structure for sidelink communication between devices in one or more unlicensed carrier, addressing one or more problems/issues and improving the efficiency of the sidelink communication between devices.

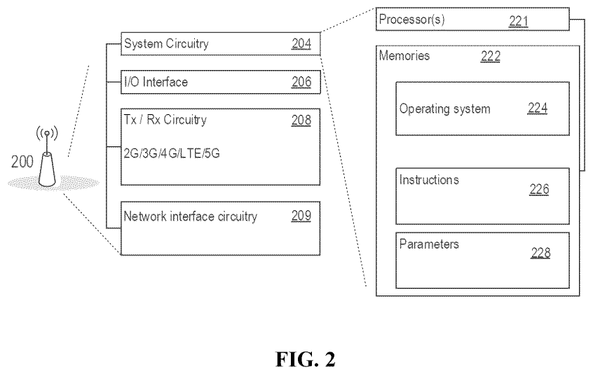

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

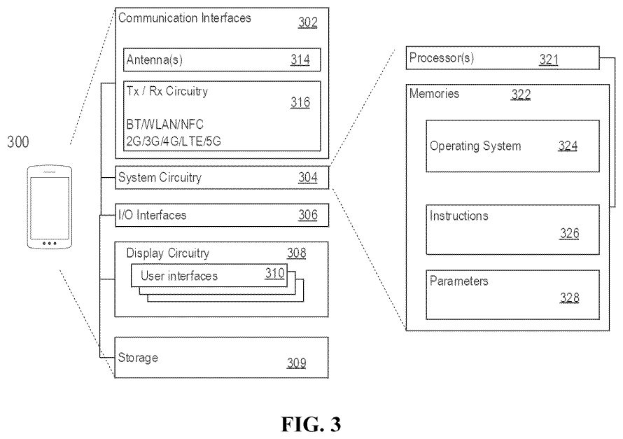

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G, 6G, and/or any future generations of telecommunication standards. The techniques described below; however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, any future telecommunication generation, or other data that the UE 300 will send, or has received, through the communication interfaces 302. In various implementations, a system power for the UE 300 may be supplied by a power storage device, such as a battery or a transformer.

The present disclosure describes various embodiments for configuring a frame structure for sidelink communication between devices in one or more unlicensed carrier, which may be implemented, partly or totally, on an apparatus for wireless communication, which may be one or more electronic device 200 and/or one or more terminal device 300 described above in FIGS. 2-3. In various embodiments of the present disclosure, a frame structure for device-to-device communication may be configured to be suitable for unlicensed carriers, including physical sidelink channel access information/channel (PSCACH). The PSCACH signal or channel is mapped on the first N symbols of the frame structure, so that the receiving UE may decode and obtain the channel sharing situation faster, and then prepare the sidelink signal sent by itself earlier (or in time). In some other implementations, sidelink communication may continue to use the originally defined SCI format on unlicensed spectrum, reducing the impact on the original standard.

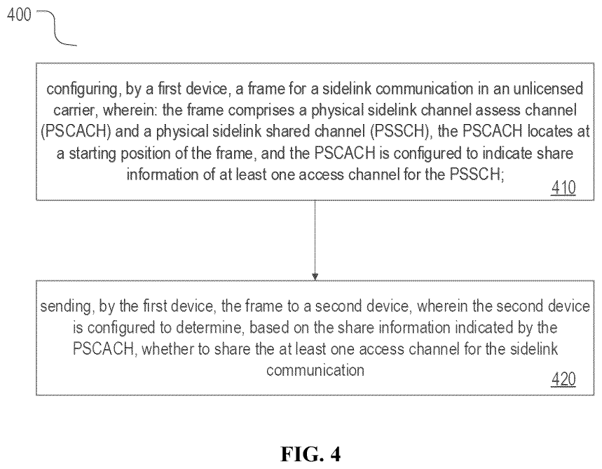

In various embodiments, referring to FIG. 4, a method 400 for wireless communication includes configuring a frame structure for sidelink communication between devices. The method 400 may include a portion or all of the following steps: step 410, configuring, by a first device, a frame for a sidelink communication in an unlicensed carrier, wherein: the frame comprises a physical sidelink channel assess channel (PSCACH) and a physical sidelink shared channel (PSSCH), the PSCACH locates at a starting position of the frame, and the PSCACH is configured to indicate share information of at least one access channel for the PSSCH; and/or step 420, sending, by the first device, the frame to a second device, wherein the second device is configured to determine, based on the share information indicated by the PSCACH, whether to share the at least one access channel for the sidelink communication. In various embodiments, a “frame” may refer to a slot, or a frame with a certain frame structure including a set of slots or a portion of symbols in a set of slots. In various embodiments, a “frame” may not necessarily have same meaning as a wireless frame in some telecommunication implementations.

In some implementations, the frame comprises a physical sidelink control channel (PSCCH); and/or the PSCACH is configured to occupy same frequency resource as the PSCCH.

In some other implementations, the PSCACH and the PSCCH are adjacent to each other in the frame.

In some other implementations, the PSCACH is configured to occupy same frequency resource as the PSSCH.

In some other implementations, the PSCACH is configured to occupy frequency resource indicated by a system message, and/or the PSCACH is predefined to occupy a number of occupied frequency resources.

In some other implementations, the frequency resource comprises at least one of the following: a number of physical resource blocks (PRBs), one or more subchannel, and/or one or more interval resource block (IRB).

In some other implementations, the PSCACH is configured to occupy starting N symbols in the frame, N being a positive integer.

In some other implementations, each of the N symbols comprises at least one of the following: a symbol corresponding to a sub-carrier space (SCS) of a PSCCH, a symbol corresponding to a SCS of the PSSCH, a symbol corresponding to a SCS of sidelink bandwidth part (BWP), a symbol corresponding to a pre-configured SCS for the PSCACH, and/or a pre-configured symbol.

In some other implementations, the N is predefined or configured by a configuration message; and/or the pre-configured SCS is predefined or configured by the configuration message. In some other implementations, the N is 2.

In some other implementations, the N symbols comprises a first symbol and a second symbol; and/or the second symbol is duplicative with the first symbol.

In various embodiments, in a slot, the sidelink time-frequency resources may include at least one of the following: a physical sidelink channel access resource area (e.g., PSCACH), PSCCH resource area, PSSCH resource area. Among them, the channel access information/channel (PSCACH), PSCCH, and demodulation reference signal (DMRS) (if any) corresponding to the PSSCH are mapped to their corresponding resource regions, and no special description is given here.

In some implementations, the sidelink time-frequency resources may refer to time-frequency resources that can be used for sidelink communication, such as resources in a sidelink resource pool. The time domain includes a specific number of symbols, and the frequency domain includes one or more sub-channels, or one or more physical resource blocks (PRBs), or one or more interval resource blocks (IRBs). The IRB is a set of PRBs spaced apart in the frequency domain.

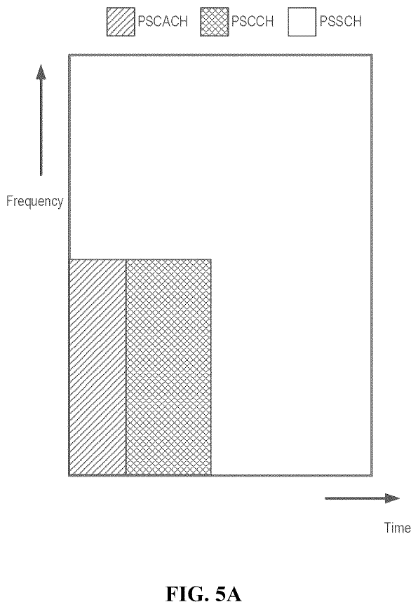

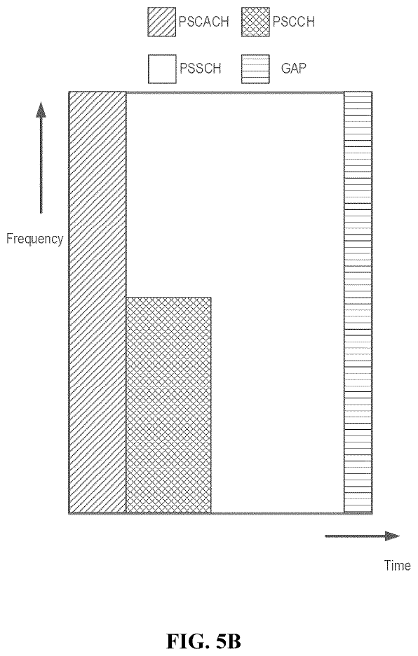

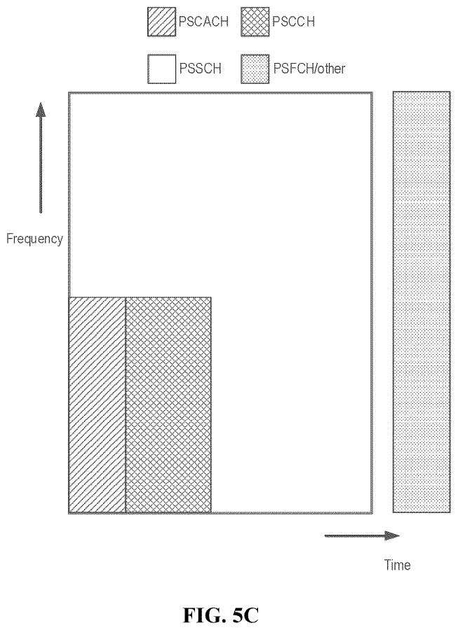

FIG. 5A shows that, in some implementations, a PSCACH frequency domain bandwidth (or frequency domain resources) may be the same as PSCCH. FIG. 5B shows that, in some implementations, a PSCACH frequency domain bandwidth (or frequency domain resources) may be the same as PSSCH. FIG. 5C shows that, in some implementations, a PSCACH resource area and a portion of PSCCH resource area may be shared in time domain.

In some implementations, the PSCACH frequency domain bandwidth (or frequency domain resources) may be the same as PSCCH, or the same as the resource pool bandwidth (or frequency domain resources), or the same as 1 subchannel bandwidth (or frequency domain resources), or the same as the PSSCH frequency, or the same as the PSSCH frequency, which is obtained by repetition of a subchannel bandwidth of PSCACH. In some other implementations, the PSCACH frequency domain resource bandwidth (or frequency domain resource) may be the same or the same as the resource pool bandwidth. In some other implementations, the PSCACH frequency domain resource bandwidth (or frequency domain resource) may be determined by the indication of a resource pool configuration message.

In some other implementations, the PSCACH may occupy, in time domain, the first N symbols of the frame structure, or on part of the first N symbols of the frame structure. The symbols for the PSCACH may be the same SCS (Sub Carrier Space) symbols as PSCCH/PSSCH (SCS symbols configured by the sidelink BWP), or independently set or predefined SCS symbols (PSCACH SCS corresponding symbols). In some other implementations, PSCCH, or PSSCH is mapped in the symbols after PSCACH.

Here, “first” N symbols in a frame/slot may refer to the “earliest” N symbols in the frame/slot, and do not merely refer to “some” symbols in the frame/slot. As PSCACH occupies the “earliest” N symbols in the frame/slot, upon receiving the frame/slot, a receiving UE may receive and decode information from the PSCACH at the earliest time.

Optionally in some other implementations, PSCACH may be extended forward to part of the symbols in the previous slot (the symbols of the SCS configured by the sidelink BWP). The number of symbols is predefined or indicated by the resource pool configuration message. The SCS of the symbol is indicated or predefined by the configuration message.

In some other implementation, a frame/slot may include a PSFCH resource area, auxiliary message indication area, etc. Referring to FIG. 5C, the channel access resource area (PSCACH) may be time-division multiplexed with the PSCCH resource area. If the PSFCH is not included in the current slot, the PSSCH may be mapped to the sidelink resources except for the PSCACH, PSCCH resource area, and gap symbols. The location of other time-frequency resources. If the PSFCH is included in the current slot, the PSSCH may be mapped to other time-frequency resource positions in the sidelink resource except for the PSCACH, PSCCH, PSFCH resource area, and gap symbols.

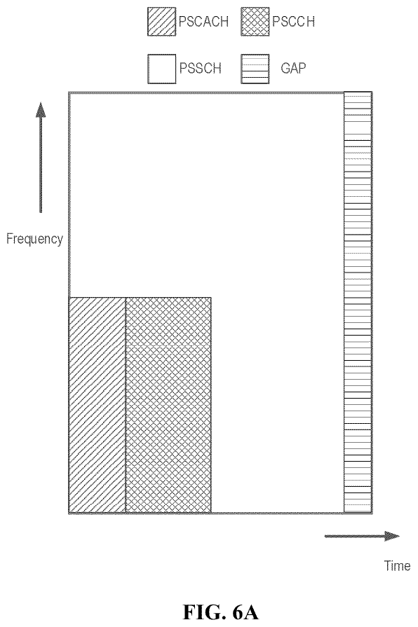

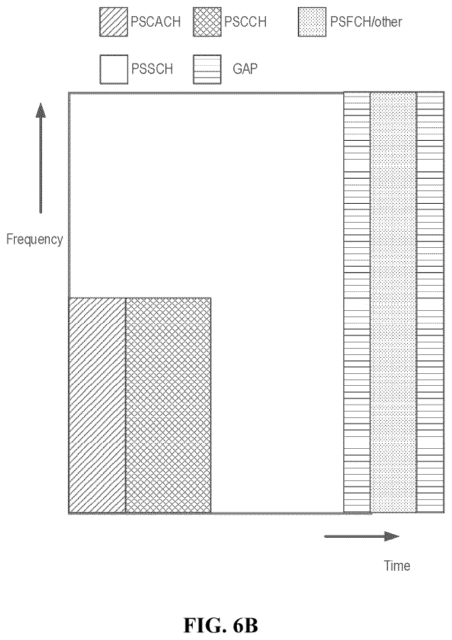

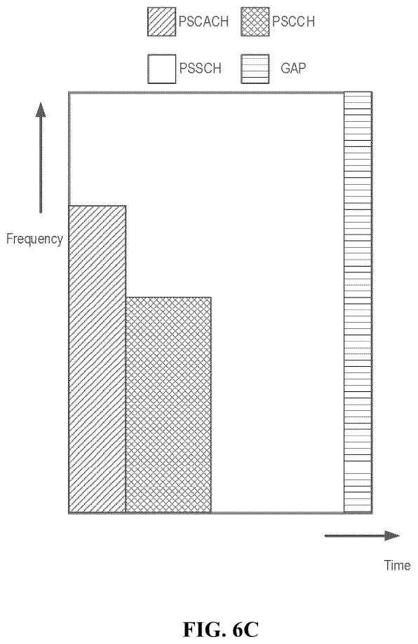

Referring to FIG. 6A, in one exemplary implementation, PSCACH may include, in frequency domain, the same as PSCCH, and, in the time domain, may be fixed with 2 symbols. According to the resource pool configuration, the sidelink time-frequency resource may include 14 symbols of a slot in the time domain, N sub-channels in the frequency domain, and each subchannel includes 15 PRBs. A UE may use one of the sub-channels on a slot to send sidelink information. The channel access resource area (PSCACH) and the PSCCH resource area may occupy the same bandwidth or number of PRBs in the frequency domain, such as 10 PRBs. In the time domain, the access resource area (PSCACH) uses 2 symbols, and the information content mapped on the two symbols is the same. For one example, symbol 1 of the two symbols is a repetition of symbol 2 of the two symbols; or for another example, the symbol 2 is a repetition of the symbol 1. The PSCCH resource area may use 3 symbols according to the resource pool configuration. In the current sub-channel, the PSSCH may be mapped to other time-frequency resource locations in the sidelink resources except for the PSCACH, PSCCH resource area, and gap symbols.

For the two symbols used in the access resource area (PSCACH), a symbol length may be same corresponding to PSCCH, PSSCH with the symbol corresponding to the SCS; or the symbol length may also be indicated by the configuration message or predefined by the symbol corresponding to the SCS. For example, the symbol of PSSCH is the symbol corresponding to SCS 15 kHz, and the symbol of PSCACH is the symbol corresponding to SCS 30 KHz. The SCS of the PSCACH is indicated by a configuration message, or is predefined, or an SCS corresponding to the SCS of the PSCCH and PSSCH.

Referring to FIG. 6B, in another exemplary implementation, PSCACH may include, in frequency domain, the same as PSCCH, and, in the time domain, may be configured with 2 symbols. According to the resource pool configuration, the sidelink time-frequency resource (sidelink slot) includes 14 symbols of a slot in the time domain, one or more IRBs in the frequency domain. Each IRB includes 20 PRBs, and is composed of discrete PRB sets that are discontinuous in the frequency domain. In some implementations, an IRB may be regarded as a logically continuous RB set, or as a logical sub-channel continuous in the frequency domain. A UE may use one of the IRBs (or logically continuous RB set, or sub-channel) in one slot to send sidelink information. A slot is additionally configured with PSFCH resource area/auxiliary message indication area, etc.

The channel access resource area (PSCACH) and the PSCCH resource area occupy the same bandwidth or number of PRBs in the frequency domain, such as 10 PRBs. In the time domain, the access resource area (PSCACH) uses 2 symbols as indicated by the configuration message, of which the information content mapped on the two symbols is the same. For one example, symbol 1 of the two symbols is a repetition of symbol 2 of the two symbols; or for another example, the symbol 2 is a repetition of the symbol 1. The PSCCH resource area uses 3 symbols according to the resource pool configuration. In the current IRB (or logically continuous RB set, or sub-channel), the PSSCH is mapped to other time-frequency resource locations in the sidelink resources except for PSCACH, PSCCH, PSFCH/auxiliary messages indicating resource regions and gap symbols.

Referring to FIG. 6C, in another exemplary implementation, PSCACH may be indicated, in frequency domain, by a system message, and, in the time domain, may include 2 symbols. According to the resource pool configuration, the sidelink time-frequency resource (sidelink slot) may include 10 symbols of a slot in the time domain, and a plurality of sub-channels in the frequency domain, and each subchannel includes 15 PRBs. The sub-channel may be composed of a certain number of PRBs that are continuous in the frequency domain, or composed of a certain number of PRBs that are discontinuous in the frequency domain. A UE may use two of the sub-channels in a slot to send sidelink information.

The channel access resource area (PSCACH) frequency domain resources may be indicated by one or more configuration messages, such as indicating a certain number of PRBs, or one of a fixed number of PRBs, or the number of PRBs contained in a sub-channel, or an IRB in the resource pool, or the same bandwidth or frequency domain resource as the PSSCH. For example, the frequency domain resource configured for PSCACH may be a subchannel, including 15 PRBs. The PSCCH uses the configured number of PRBs: 10 PRBs. In the time domain, the access resource area (PSCACH) uses 2 symbols, and the information content mapped on the two symbols is the same. For one example, symbol 1 of the two symbols is a repetition of symbol 2 of the two symbols; or for another example, the symbol 2 is a repetition of the symbol 1. The PSCCH resource area may use 3 symbols according to the resource pool configuration. In the current sub-channel, the PSSCH may be mapped to other time-frequency resource locations in the sidelink resources except for the PSCACH, PSCCH resource area, and gap symbols.

In another exemplary implementation, PSCACH may include, in the frequency domain, a predefined subchannel, and, in the time domain, a number of symbols that may be configured. According to the resource pool configuration, the sidelink time-frequency resource (sidelink slot) may include 14 symbols of a slot in the time domain, and a plurality of sub-channels in the frequency domain, and each subchannel includes 15 PRBs. The sub-channel may be composed of a certain number of PRBs that are continuous in the frequency domain, or composed of a certain number of PRBs that are discontinuous in the frequency domain. According to the resource allocation indication message, such as DCI (Downlink control information), the UE may use two sub-channels in a slot to send sidelink information.

The channel access resource area (PSCACH) frequency domain resource may be predefined as 1 subchannel, including 15 PRBs. The PSCCH uses the configured number of PRBs: 10 PRBs. In the time domain, the access resource area (PSCACH) configuration uses 2 symbols, of which the information content mapped on the two symbols is the same. For one example, symbol 1 of the two symbols is a repetition of symbol 2 of the two symbols; or for another example, the symbol 2 is a repetition of the symbol 1. The symbol is a symbol corresponding to the SCS indicated by the configuration message, or a pre-defined symbol of the SCS corresponding to the SCS of the PSCCH and the PSSCH (the symbol corresponding to the PSCACH SCS). The PSCCH resource area uses 3 symbols according to the resource pool configuration. In the current sub-channel, the PSSCH is mapped to other time-frequency resource locations in the sidelink resources except for the PSCACH, PSCCH resource area, and gap symbols.

In various embodiments, the share information comprises at least one of the following: a channel access priority class (CAPC), a channel occupancy time (COT), a remaining channel occupancy time (RCOT), a group identifier (ID), a destination identifier (ID), or a share channel indication.

The channel access priority class (CAPC) may indicate a channel access priority level used by a UE currently competing for the channel. In some implementations, when the resources used by the UE are within the shared duration indicated by other UEs, the channel access priority class (CAPC) may indicate the channel access priority level indicated by other UEs.

The channel occupation time (COT) may indicate the channel occupation time obtained by the UE currently competing for the channel.

The remaining channel occupancy time (RCOT) may indicate the remaining time of the channel occupation obtained by the UE currently competing for the channel minus its own current transmission time. When the resource used by the UE is within the shared time indicated by other UEs, the remaining time of the channel occupation obtained by the UE is the indicated channel occupancy time or the remaining channel occupancy time for other UE minus the current transmission time for the current UE.

The group information (Group ID) indicates the group ID allowed by the shared channel, that is, in the same group (the Group ID is the same), the acquired resources may be used for sidelink transmission.

The share channel indication may indicate (such as the channel number) the identity of the shared channel, that is, in the channel indicated by the indicated shared channel information, the acquired resources may be used for sidelink transmission.

In some implementations, the share information is carried by a sequence, wherein: a length of the sequence indicates a number of resource elements (REs) used by the PSCACH in a symbol, a creation ID of the sequence indicates the CAPC, or a number of cyclic steps of the sequence indicates the COT or the RCOT.

In some other implementations, the share information is carried by a sequence, wherein: a length of the sequence indicates a number of resource elements (REs) used by the PSCACH in a symbol, or the sequence indicates the COT or the RCOT.

In some other implementations, the share information is carried by a sequence, wherein: a length of the sequence indicates a number of resource elements (REs) used by the PSCACH in a symbol, or the sequence indicates the CAPC.

In some other implementations, the share information is carried by a number of bit fields, wherein the number of bit fields includes at least one of the following: a bit field indicating the CAPC, a bit field indicating the COT, a bit field indicating the RCOT, a bit field indicating the group ID, a bit field indicating the destination ID, or a bit field indicating the share channel indication.

In some other implementations, the share channel indication indicates a channel number.

The present invention also provides a method for device-to-device communication, which is used for sending devices:

The sending UE obtains the transmission resource (grant) authorized by the sidelink. When the UE monitors the channel and confirms that the channel is available, it uses the above-mentioned sidelink frame structure to send a sidelink signal, where the channel access information/channel indicates the channel sharing information,

In one exemplary implementation, the channel sharing information may be carried by a sequence. A sequence length may indicate the number of REs used by PSCACH on one symbol, the sequence generation ID indicates the channel access priority level; the cyclic shift number of the sequence indicates the channel occupation time or the remaining channel occupation time.

In another exemplary implementation, the channel sharing information is carried by a sequence. The sequence length may indicate the number of REs used by the PSCACH on one symbol, and each sequence indicates a channel occupation time period or a channel occupation remaining time period.

In another exemplary implementation, the channel sharing information is carried by a sequence. The sequence length may indicate the number of REs used by PSCACH on one symbol, and each sequence indicates a channel access priority level.

In another exemplary implementation, the channel sharing information is indicated by the channel access message/channel bit overhead, and includes at least one of the following indication fields: a channel access priority class (CAPC), and/or a channel occupancy time (COT), and/or a remaining channel occupancy time (RCOT), and/or a group identifier (ID), and/or a destination identifier (ID), and/or a share channel indication.

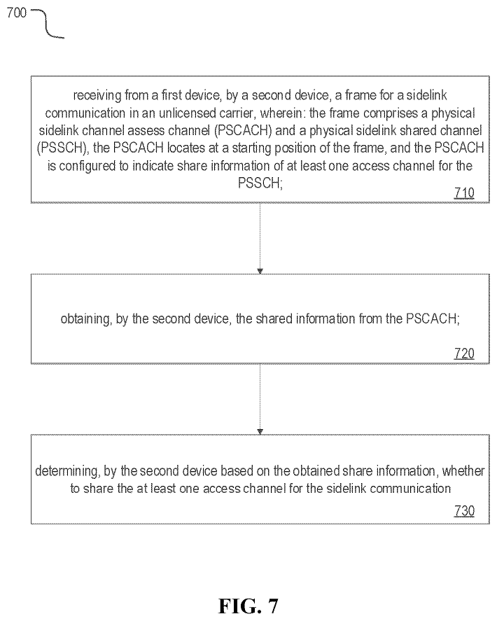

In various embodiments, referring to FIG. 7, a method 700 for wireless communication includes configuring a frame structure for sidelink communication between devices. The method 700 may include a portion or all of the following steps: step 710, receiving from a first device, by a second device, a frame for a sidelink communication in an unlicensed carrier, wherein: the frame comprises a physical sidelink channel assess channel (PSCACH) and a physical sidelink shared channel (PSSCH), the PSCACH locates at a starting position of the frame, and the PSCACH is configured to indicate share information of at least one access channel for the PSSCH; step 720, obtaining, by the second device, the shared information from the PSCACH; and/or step 730, determining, by the second device based on the obtained share information, whether to share the at least one access channel for the sidelink communication. In various embodiments, a “frame” may refer to a slot, or a frame with a certain frame structure including a set of slots or a portion of symbols in a set of slots. In various embodiments, a “frame” may not necessarily have same meaning as a wireless frame in some telecommunication implementations.

In some implementations, the share information comprises at least one of the following: a channel access priority class (CAPC), a channel occupancy time (COT), a remaining channel occupancy time (RCOT), a group identifier (ID), a destination identifier (ID), or a share channel indication.

The channel access priority class (CAPC) may indicate a channel access priority level used by a UE currently competing for the channel. In some implementations, when the resources used by the UE are within the shared duration indicated by other UEs, the channel access priority class (CAPC) may indicate the channel access priority level indicated by other UEs.

The channel occupation time (COT) may indicate the channel occupation time obtained by the UE currently competing for the channel.

The remaining channel occupancy time (RCOT) may indicate the remaining time of the channel occupation obtained by the UE currently competing for the channel minus its own current transmission time. When the resource used by the UE is within the shared time indicated by other UEs, the remaining time of the channel occupation obtained by the UE is the indicated channel occupancy time or the remaining channel occupancy time for other UE minus the current transmission time for the current UE.

The group information (Group ID) indicates the group ID allowed by the shared channel, that is, in the same group (the Group ID is the same), the acquired resources may be used for sidelink transmission.

The share channel indication may indicate (such as the channel number) the identity of the shared channel, that is, in the channel indicated by the indicated shared channel information, the acquired resources may be used for sidelink transmission.

In some other implementations, in response to current transmission of the second device satisfying the CAPC, the second device determines to share the at least one access channel for the sidelink communication.

In some other implementations, in response to current granted resource of the second device satisfying the COT or the RCOT, the second device determines to share the at least one access channel for the sidelink communication.

In some other implementations, in response to current transmission of the second device satisfying the CAPC and current granted resource of the second device satisfying the COT or the RCOT, the second device determines to share the at least one access channel for the sidelink communication.

In some other implementations, in response to current transmission of the second device satisfying the group ID, the second device determines to share the at least one access channel for the sidelink communication.

In some other implementations, in response to current transmission of the second device satisfying at least one channel indicated by the share channel indication, the second device determines to share the at least one access channel for the sidelink communication.

In various embodiments, according to the received channel sharing information, a receiving device may determine whether the resource within the sharing duration range indicated by the use may be shared.

In one exemplary implementation, the determination may be at least based on priority condition. A receiving device may determine whether a current transmission meets the channel access priority level requirements indicated by other UEs. For one example, its own channel access priority level is equal to or not less than the channel access priority level indicated by other UEs; or for another example, its own channel access priority level indicator value is equal to or is not greater than the channel access priority indicated by other UEs. In some implementation, the larger the channel access priority level indicator value, the lower the corresponding channel access priority level. When the conditions are met, it indicates that the receiving device is allowed to use the acquired resources for sidelink transmission.

In another exemplary implementation, the determination may be at least based on channel sharing duration condition. A receiving device may determine whether the resource location (grant) the receiving device has obtained meets the channel occupation time requirements indicated by other UEs. For example, whether the resources the receiving device has obtained is within the channel occupation time indicated by other UEs, or for another example, whether it's within the remaining channel occupation time indicated by other UEs. When the conditions are met, it means that the receiving device is allowed to use the resources you have obtained for sidelink transmission.

In another exemplary implementation, the determination may be at least based on the priority and sharing duration conditions at the same time. A receiving device may determine whether a current transmission of the receiving device meets the channel access priority level requirements indicated by other UEs and whether the receiving device meets the channel occupancy time requirements indicated by other UEs. If the channel access priority level requirements and the channel occupancy time/channel occupancy remaining time requirements are met at the same time, it indicates the receiving device is allowed to use the acquired resources for sidelink transmission.

In another exemplary implementation, the determination may be at least based on group identification. Based on the received group information (Group ID) indicated by the PSCACH, a receiving device may determine whether the current transmission belongs to the group indicated by other UEs (the Group ID is the same). When the conditions are met, it indicates that the receiving device may use the acquired resources for sidelink transmission.

In another exemplary implementation, the determination may be at least based on destination identification. Based on the received destination information or destination identifier (Destination ID) indicated by the PSCACH, a receiving device may determine whether the current transmission belongs to the destination indicated by other UEs (the Destination ID indicated by other UEs is the same as the source ID of the UE). When the conditions are met, it indicates that the receiving device may use the acquired resources for sidelink transmission.

In another exemplary implementation, the determination may be at least based on channel indication. Based on the received shared channel information indication (such as the channel number or channel identification number) indicated by the PSCACH, and the receiving device may determine whether the current transmission is in the channel of the shared channel number indicated by other UEs. When the conditions are met, it indicates that the receiving device may use the acquired resources for sidelink transmission.

The present disclosure describes methods, apparatus, and non-transitory computer-readable storage medium for wireless communication. The present disclosure addressed the issues with configuring a frame structure for sidelink communication between devices. The methods, devices, and non-transitory computer-readable storage medium described in the present disclosure may facilitate the performance of wireless communication by configuring a frame structure for sidelink communication between devices, thus improving efficiency and overall performance. The methods, apparatuses, and non-transitory computer-readable storage medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
configuring, by a first device, a frame for a sidelink communication in an unlicensed carrier, wherein:
the frame comprises a physical sidelink channel assess channel (PSCACH) and a physical sidelink shared channel (PSSCH),
the PSCACH locates at a starting position of the frame, and
the PSCACH is configured to indicate share information of at least one access channel for the PSSCH; and
sending, by the first device, the frame to a second device, wherein the second device is configured to determine, based on the share information indicated by the PSCACH, whether to share the at least one access channel for the sidelink communication.

2. The method according to claim 1, wherein:
the frame comprises a physical sidelink control channel (PSCCH); and
the PSCACH is configured to occupy same frequency resource as the PSCCH.

3. The method according to claim 2, wherein:
the PSCACH and the PSCCH are adjacent to each other in the frame.

4. The method according to claim 1, wherein:
the PSCACH is configured to occupy same frequency resource as the PSSCH.

5. The method according to claim 1, wherein:
the PSCACH is configured to occupy frequency resource indicated by a system message, or
the PSCACH is predefined to occupy a number of occupied frequency resources.

6. The method according to claim 2, wherein:
the frequency resource comprises at least one of the following:
a number of physical resource blocks (PRBs),
one or more subchannel, or
one or more interval resource block (IRB).

7. The method according to claim 1, wherein:
the PSCACH is configured to occupy starting N symbols in the frame, N being a positive integer.

8. The method according to claim 7, wherein:
each of the N symbols comprises at least one of the following:
a symbol corresponding to a sub-carrier space (SCS) of a PSCCH,
a symbol corresponding to a SCS of the PSSCH,
a symbol corresponding to a SCS of sidelink bandwidth part (BWP),
a symbol corresponding to a pre-configured SCS for the PSCACH, or
a pre-configured symbol.

9. The method according to claim 8, wherein:
N is predefined or configured by a configuration message; and
the pre-configured SCS is predefined or configured by the configuration message.

10. The method according to claim 8, wherein:
N is 2; and
wherein:
the N symbols comprises a first symbol and a second symbol; and
the second symbol is duplicative with the first symbol, or the first symbol is duplicative with the second symbol.

11. (canceled)

12. The method according to claim 1, wherein:
the share information comprises at least one of the following:
a channel access priority class (CAPC),
a channel occupancy time (COT),
a remaining channel occupancy time (RCOT),
a group identifier (ID),
a destination identifier (ID), or
a share channel indication; and
wherein:
the share channel indication indicates a channel number.

13. The method according to claim 12, wherein:
the share information is carried by a sequence, wherein:
a length of the sequence indicates a number of resource elements (REs) used by the PSCACH in a symbol,
a creation ID of the sequence indicates the CAPC, or
a number of cyclic steps of the sequence indicates the COT or the RCOT.

14. The method according to claim 12, wherein:
the share information is carried by a sequence, wherein:
a length of the sequence indicates a number of resource elements (REs) used by the PSCACH in a symbol, or
the sequence indicates the COT or the RCOT.

15. The method according to claim 12, wherein:
the share information is carried by a sequence, wherein:
a length of the sequence indicates a number of resource elements (REs) used by the PSCACH in a symbol, or
the sequence indicates the CAPC.

16. The method according to claim 12, wherein:
the share information is carried by a number of bit fields, wherein the number of bit fields includes at least one of the following:
a bit field indicating the CAPC,
a bit field indicating the COT,
a bit field indicating the RCOT,
a bit field indicating the group ID,
a bit field indicating the destination ID, or
a bit field indicating the share channel indication.

17. (canceled)

18. A method for wireless communication, comprising:
receiving from a first device, by a second device, a frame for a sidelink communication in an unlicensed carrier, wherein:
the frame comprises a physical sidelink channel assess channel (PSCACH) and a physical sidelink shared channel (PSSCH),
the PSCACH locates at a starting position of the frame, and
the PSCACH is configured to indicate share information of at least one access channel for the PSSCH;
obtaining, by the second device, the shared information from the PSCACH; and
determining, by the second device based on the obtained share information, whether to share the at least one access channel for the sidelink communication.

19. The method according to claim 18, wherein:
the share information comprises at least one of the following:
a channel access priority class (CAPC),
a channel occupancy time (COT),
a remaining channel occupancy time (RCOT),
a group identifier (ID),
a destination identifier (ID), or
a share channel indication.

20. The method according to claim 19, wherein:
in response to current transmission of the second device satisfying the CAPC, the second device determines to share the at least one access channel for the sidelink communication;
or, wherein:
in response to current granted resource of the second device satisfying the COT or the RCOT, the second device determines to share the at least one access channel for the sidelink communication;
or, wherein:
in response to current transmission of the second device satisfying the CAPC and current granted resource of the second device satisfying the COT or the RCOT, the second device determines to share the at least one access channel for the sidelink communication;
or, wherein:
in response to current transmission of the second device satisfying the group ID, the second device determines to share the at least one access channel for the sidelink communication;
or, wherein:
in response to current transmission of the second device satisfying at least one channel indicated by the share channel indication, the second device determines to share the at least one access channel for the sidelink communication.

21-24. (canceled)

25. An apparatus for wireless communication, comprising a processor and a memory, wherein:
in response to the apparatus being a first device, the processor is configured to read instructions from the memory and implement:
configuring a frame for a sidelink communication in an unlicensed carrier, wherein:
the frame comprises a physical sidelink channel assess channel (PSCACH) and a physical sidelink shared channel (PSSCH),
the PSCACH locates at a starting position of the frame, and
the PSCACH is configured to indicate share information of at least one access channel for the PSSCH; and
sending the frame to a second device, wherein the second device is configured to determine, based on the share information indicated by the PSCACH, whether to share the at least one access channel for the sidelink communication,
or, in response to the apparatus being a second device, the processor is configured to read instructions from the memory and implement:
receiving from a first device a frame for a sidelink communication in an unlicensed carrier, wherein:
the frame comprises a physical sidelink channel assess channel (PSCACH) and a physical sidelink shared channel (PSSCH),
the PSCACH locates at a starting position of the frame, and
the PSCACH is configured to indicate share information of at least one access channel for the PSSCH;
obtaining the shared information from the PSCACH; and
determining, based on the obtained share information, whether to share the at least one access channel for the sidelink communication.

26. A non-transitory computer-readable storage medium instructions stored thereupon, the instructions, when executed by a processor, causing the processor to implement the method recited in claim 1.
